(19) United States
(12) Patent Application Publication
(10) Pub. No.: US 2012/0090796 A1
(43) Pub. Date: Apr. 19, 2012

(54) Magnetic curtain for steel door entrance way window

(76) Inventor: Arlene D'Ambrosia, Toms River, NJ (US)

(21) Appl. No.: 13/136,874

(22) Filed: Aug. 15, 2011

Related U.S. Application Data
(60) Provisional application No. 61/455,068, filed on Oct. 15, 2010.

(51) Int. Cl. A47H 23/00; F16B 47/00; B26D 7/27; H01F 7/02

(52) U.S. Cl. 160/330; 83/821

(57) ABSTRACT

A magnetic curtain of light impervious or light interrupting material having a plurality of magnets positioned in its periphery, the magnetic curtain sized to magnetically adhere to the interior surface of a steel entrance door and cover the decorative window formed therein.

### RELATED APPLICATIONS

Applicant claims the benefit of provisional application Ser. No. 61/455,068, filed Oct. 15, 2010.

### BACKGROUND OF THE INVENTION

1. Field of the Invention

The present invention is directed to entrance way doors that are constructed of steel, and in particular, to those which include a decorative window, and more particularly to a magnetic curtain adapted to the shape of the decorative window which can be selectively positioned about and over the decorative window to prevent unwanted visual intrusion.

2. Description of the Prior Art

Entrance way doors constructed of wood for the ingress and egress into a dwelling have been used since the beginning of home building. As civilizations evolved, these wood doors became more ornate and oftentimes included one or more glass panels for the passage of light. These window panels also allow the homeowner to look outwardly if so desired. The window panels on wooden doors were easily covered through the use of mini curtains mounted on mini curtain rods affixed to the interior surface of the wooden door allowing the homeowner to choose whether to allow the passage of light or not.

In recent years, steel doors have become very popular as the primary entranceway into a home. The steel doors offer better security and many also carry warranties with respect to rust and also the paint finish applied to the doors and baked on during the manufacturing process thereby alleviating the need for the home owner to either paint or stain the door during its lifetime.

Many of these steel doors are now also manufactured with decorative windows which can come in many shapes, including geometric shapes, ovals, tear drop, arch type or other arcuate shapes. These decorative windows may also include a design or an indicia such as the first letter of the homeowners' last name. Steel doors with these decorative windows incorporated therein allow the home owner to add his own personal aesthetic touch to the entrance way to his home, however, these doors do have one drawback in that at night, with the interior lights of the dwelling lit, an individual passing by the exterior of the house can directly view at least a portion of the interior of the house. Additionally, depending upon the orientation of the house and the steel door with incorporated decorative window, headlights from passing traffic may also cast light through the decorative window and into the home.

Since the door is made of steel, it cannot easily accept a curtain rod and in all likelihood, the drilling of holes to secure such a curtain rod would in all likelihood void any warranties associated with the steel door. Still further, the curtain rod would detract from the aesthetics of the door as viewed from the interior of the house during daylight hours.

There therefore has been a need for a selectively removable curtain for use with a metal door that adapts to the shape of the decorative window and covers the decorative window of the steel door during the evening hours. Applicant's magnetic curtain is designed to adapt to the shape and cover such decorative windows regardless of their shape by providing a light impervious fabric material having a plurality of magnets formed in or about the periphery of the curtain which can be selectively magnetically attached about the decorative window and its trim, if any, during the evening hours, and removed and stored in a drawer during daylight hours.

### OBJECTS OF THE INVENTION

An object of the present invention is to provide for a novel magnetic curtain for use with steel doors having decorative windows in order to cover the decorative windows on the interior side of the door during evening hours, the magnetic curtain adapting to the shape of the window.

It is another object of the present invention to provide for a novel magnetic curtain which is easily installed without damaging the steel door.

It is a still further object of the present invention to provide for a novel magnetic curtain for a steel door which is easily removed and stored when not in use.

It is a further object of the present invention to provide for a novel magnetic curtain for a steel door which is sold in kit form with a plurality of magnets and sewing patterns which allow the homeowner to select his or her own curtain fabric material and construct a magnetic curtain for the particular decorative window in the steel door.

### SUMMARY OF THE INVENTION

A magnetic curtain of light impervious or light interrupting fabric having a plurality of magnets positioned in its periphery, the magnetic curtain sized to magnetically adhere to the interior surface of a steel entrance door and cover the decorative window formed therein.

### BRIEF DESCRIPTION OF THE DRAWINGS

These and other objects of the present invention will become apparent, particularly when taken in light of the following illustrations wherein:

FIGS. 1A, 1B, and 1C are rear interior views of a typical steel front entrance door which incorporates a variety of decorative windows;

FIG. 2 is a rear view of a steel front entrance door in which a magnetic curtain of the present invention has been installed over the decorative window;

FIG. 3 is a perspective exploded view of one embodiment of the decorative curtain of the present invention; and

FIG. 4 is a cross-sectional view of a second embodiment of the decorative curtain of the present invention.

### DETAILED DESCRIPTION OF THE INVENTION

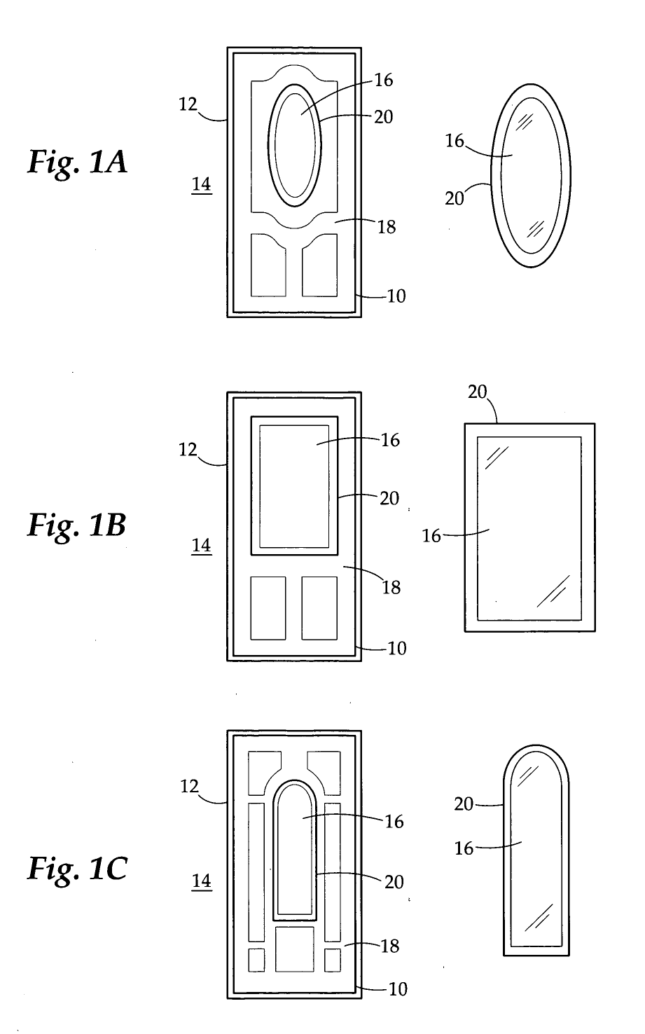

FIGS. 1A, 1B, and 1C are rear views from the interior of a dwelling, of a typical steel front entrance door which incorporates a decorative window. The steel door 10 is mounted in a frame 12 in a wall 14. The steel door incorporates a decorative window 16 which as illustrated in FIG. 1A is a vertical oval, 1B is a rectangle, and 1C is an arched vertical window. The decorative window 16 may be clear, or it may also incorporate a design or perhaps an indicia such as the first initial of the owners last name.

Depending upon the floor plan of the house, the steel front entrance door 10 may open into a hallway, a foyer, or even an actual room. Depending upon the height of the entrance door, and its mount into the wall, in the evening, with interior lights on in the house, a person passing by on the exterior of the house is allowed a view into the interior of the house. Additionally, depending upon the height of the door, and its orientation, and the houses' orientation vis-à-vis the street, the headlights of passing automobiles may also cast a light through the decorative window 16 and into the house creating a strobe light like effect. It is therefore necessary to have some type if aesthetic cover or curtain for the window during the evening hours.

FIG. 1A illustrates a steel front entrance door 10 with a vertical oval-shaped window 16 positioned approximately three quarters of the height of the steel front entrance door 10. It should be noted that the steel front entrance doors can come with a variety of windows of different shapes. Some may be geometrical incorporating straight edge sides, FIGS. 1B and 1C, and others may be arcuate in shape, FIG. 1A, such as the oval illustrated or other arcuate shapes. Still further, the positioning of the decorative window on the steel front entrance door 10 may vary. Applicant's magnetic curtain is designed to have application to all shapes of decorative windows regardless of their location.

The typical decorative window 16 may be flush with the interior surface 18 of the steel front entrance door 10, but the norm is to incorporate a non-metal periphery 20 which is slightly raised above the interior surface 18 of the steel front entrance door 10.

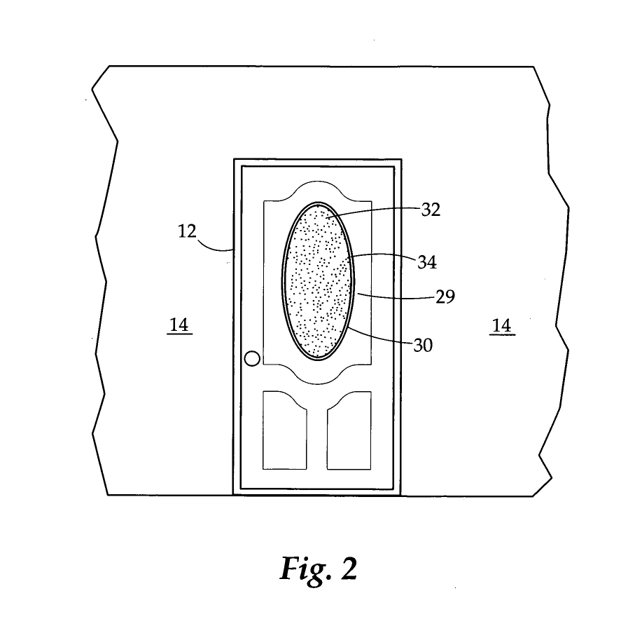

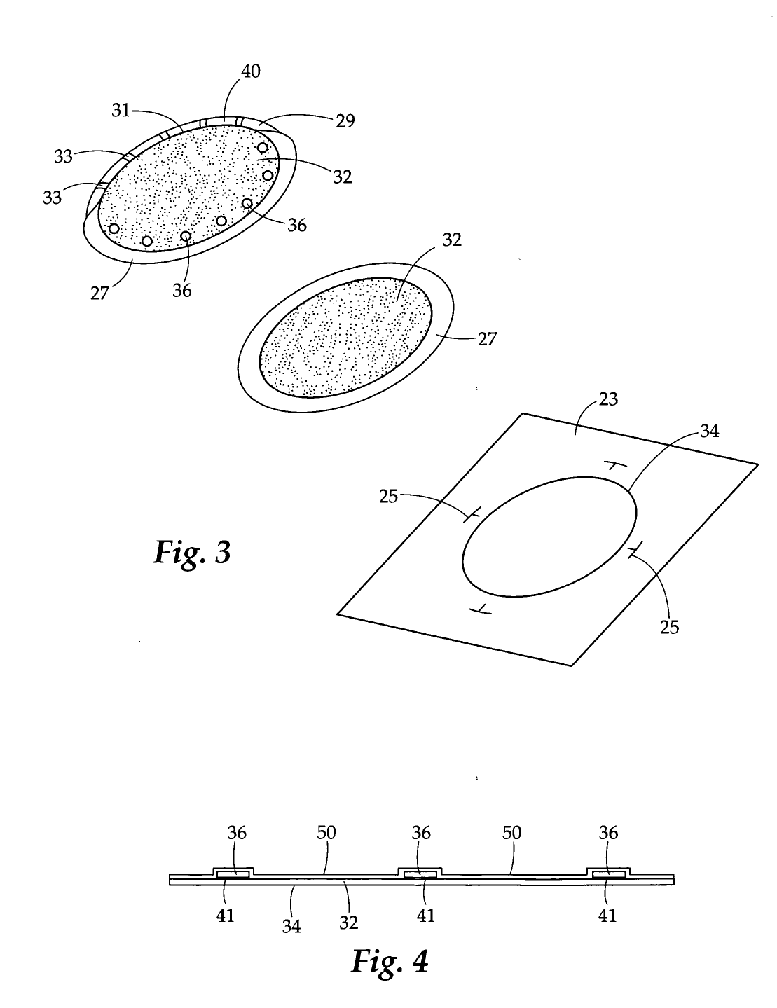

FIG. 2 is an interior or rear view of the steel front entrance door 10 of FIG. 1 having a magnetic curtain 30 of the present invention positioned over the oval decorative window of FIG. 1A. The structure of the magnetic curtain 30 will be described more particularly with additional figures, however, in essence, it consists of an opaque or semi-opaque fabric material 32 having been cut and hemmed to define a periphery 34 to match the shape of the window and to cover the oval decorative window 16 of FIG. 1A and the non-metal periphery 20 and overlap a portion of the immediate adjacent metal door surface 29. In FIG. 3, the hemmed periphery 34 incorporates a plurality of magnets 36 in spaced apart relationship, which magnets are attracted to and adhere to the interior surface 18 of the steel front entrance door 10 by magnetic attraction.

FIG. 3 is a first embodiment of a magnetic curtain 30 and its construction. A tracing template 23 has been utilized to outline the periphery 34 of the typical decorative window 16 on the interior surface 18 of a steel front door entrance 10. The outline will also include the non-metal periphery 20 if present, and a metal periphery about the non-metal periphery. The tracing template 24 includes directions and/or indicia 25 for increasing the size of the outline to account for seam allowance 27 when hemming the periphery of the fabric material 32. The outline of the tracing template is then transferred to a fabric material 32 such that it can be cut to size, including the seam allowance 27. The seam allowance 27 of the fabric material 32 would then be hemmed 29 either continuously 31 or with separate pockets 33, while a plurality of magnets 36 are positioned in hemmed periphery 40 or in their own separate pockets 33 to prevent their dislocation within the hemmed periphery 40. The magnets may be formed with an adhesive 41 (see FIG. 4) on one side of the magnet 36, which allows the magnet 36 to be positioned within the hemmed periphery 40 and adhesed to the cloth material 32 while the opposing side has sufficient magnetic attraction to adhere to the steel front entrance door 10 by magnetic attraction through the fabric material 32.

FIG. 4 illustrates a second alternative embodiment for positioning of the magnets 36. In this instance, the periphery 34 of magnetic curtain 30 is sealed with an adhesive tape 50 as opposed to sewing a hem. As such there is no requirement for seal allowance since no hemming is required. The adhesive tape 50 is adhesed to the periphery 34 and the magnets 36 are selectively positioned below the adhesive tape. Again, the magnets 36 may be formed with an adhesive layer on one side which allows that side to be adhesed to the cloth 32 while being overlapped with the adhesive tape 50 so as to maintain their position.

The magnets 36 illustrated thus far have been shown as circular, however any substantially flat geometric shape may be utilized. These magnets also may or may not have an adhesive side which allows for the magnets to be adhesed to the fabric material 32. Magnets not having an adhesive side are also acceptable to use with the magnetic curtain as the hemmed pockets 42 or the adhesive tape 50 will maintain them in position. Magnets 36 having adhesive layer could also be used directly on the fabric without having a hemmed stitching or use of the adhesive tape 50. However, the deterioration of any adhesive on the magnet may affect the aesthetic appearance of the magnetic curtain.

The shape and size of the decorative window 16 will determine the positioning and the number of magnets required. As an example, a typical square window, FIG. 1B, would nominally require only four magnets, one at each corner of the window to adhere to the interior surface 18 of the steel front entrance door 10. With respect to the oval window as illustrated in FIG. 1A, it may be necessary for additional magnets to be incorporated into the peripheral hem so as to maintain the magnetic curtain in an orientation which completely covers the oval shape decorative window.

Each home owner may have a preference for the fabric utilized with respect to Applicant's magnetic curtain. Therefore, Applicant's novel contribution also has application to a kit which allows the individual to construct a magnetic curtain with the fabric of their own choosing. Such a kit would provide for a plurality of magnets 36 and a tracing template 23. The tracing template 23 would be overlaid the decorative window 16 so as to mark the decorative windows periphery including any non-metal periphery 20 and peripheral metal portion 29. The tracing template 23 would also provide seam allowance indicia 25 if the periphery is to be hemmed. The tracing template 23 would then be placed over the fabric material 32, the fabric material 32 could be cut to size including the seam allowance portion, which then allows the individual to prepare a hem in the manner heretofore described, and to position the magnets 36 within the peripheral hem or alternately, cut fabric material 32 to size and secure with adhesive tape 50.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A magnetic curtain for steel entrance doors having a decorative window formed therein, the magnetic curtain comprising:
a fabric material having a peripheral hem defining a peripheral channel;
a plurality of magnet members disposed within said peripheral channel, said plurality of magnetic members cooperative with the inside surface of a steel entrance door so as to position and maintain said fabric material in coverage relationship to a decorative window formed in said steel entrance door.

2. The magnetic curtain in accordance with claim 1 wherein said fabric material is opaque.

3. The magnetic curtain in accordance with claim 1 wherein said fabric material is semi-opaque.

4. The magnetic curtain in accordance with claim 1 wherein said magnetic members are formed with an adhesive surface for positioning said magnetic members against said fabric.

5. The magnetic curtain in accordance with claim 1 wherein said peripheral hem of said fabric member is formed with a plurality of individual pockets for the receipt and maintaining of position of an individual said magnetic member in each of said plurality of pockets.

6. A kit for the interior coverage of a decorative window formed in a steel entrance door to prevent visual observation and light passage from the exterior of a building, the kit comprising:
a fabric material;
a tracing template for tracing of the size and shape of a decorative window, said tracing template including seam allowance indicia for hemming said fabric material periphery to define a peripheral hem;
a plurality of magnet members for disposal within said peripheral hem of said fabric material, said magnet members cooperative with the inside surface of said steel entrance door so as to position and maintain said fabric material in coverage relationship to said decorative window formed in said steel entrance door.

7. The magnetic curtain in accordance with claim 6 wherein said fabric material is opaque.

8. The magnetic curtain in accordance with claim 6 wherein said fabric material is semi-opaque.

9. The magnetic curtain in accordance with claim 6 wherein said magnetic members are formed with an adhesive surface for positioning said magnetic members against said fabric.

10. The magnetic curtain in accordance with claim 6 wherein said peripheral hem of said fabric member is formed with a plurality of individual pockets for the receipt and maintaining of position of an individual said magnetic member in each of said plurality of pockets.

11. A kit for measuring and cutting a fabric to serve as an interior coverage of a decorative window formed in a steel entrance door to prevent visual observation and light passage from the exterior of a building, the kit comprising:
a tracing template for tracing the size and shape of a decorative window positioned in a steel door, said tracing template including seam allowance indicia for hemming a fabric material periphery to define a peripheral hem coincident with the periphery of said decorative window;
a plurality of magnet members for disposal within said peripheral hem of said fabric material, said magnet members cooperative with the inside surface of said steel entrance door so as to position and maintain said fabric material in coverage relationship with said decorative window formed in said steel entrance door.

12. The magnetic curtain in accordance with claim 11 wherein said fabric material is opaque.

13. The magnetic curtain in accordance with claim 11 wherein said fabric material is semi-opaque.

14. The magnetic curtain in accordance with claim 11 wherein said magnetic members are formed with an adhesive surface for positioning said magnetic members against said fabric.

15. The magnetic curtain in accordance with claim 11 wherein said peripheral hem of said fabric member is formed with a plurality of individual pockets for the receipt and maintaining of position of an individual said magnetic member in each of said plurality of pockets.
